(19) United States
(12) Patent Application Publication
(10) Pub. No.: US 2006/0092007 A1
(43) Pub. Date: May 4, 2006

(54) System and method for notifying detected tyre operating conditions

(76) Inventor: Marco Cantu, Carnate (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/517,339

(22) PCT Filed: Jun. 10, 2002
(86) PCT No.: PCT/EP02/06332

§ 371 Date: Sep. 26, 2005

(51) Int. Cl. B60C 23/02

(52) U.S. Cl. 340/442

(57) ABSTRACT

A system for notifying detected tyre operating conditions includes a device for receiving tyre operating parameters detected by at least one sensor associated with at least one tyre of a vehicle and a device for notifying one or more persons inside the vehicle of an indication of operating conditions of the at least one tyre, determined on a basis of the received tyre operating parameters. The notifying device includes a radio data system transmission module for generating a signal receivable by a radio receiver compatible with the RDS standard, the RBDS standard, or the RDS and RBDS standards, and for transmitting the indication of the operating conditions, exploiting the RDS or RBDS protocol. The one or more persons are notified of the indication of the operating conditions through the radio receiver. A method for notifying detected operating conditions of at least one tyre of a vehicle is also disclosed.

The present invention generally relates to systems for monitoring operating parameters of vehicle tyres, such as the inflation pressure, the tyre temperature, the tyre wear, the deformation, and any other parameter useful to allow determining the conditions of the vehicle tyres. More particularly, the invention concerns a system for notifying persons inside the vehicle of the conditions of the vehicle tyres, based on the monitored parameters.

The wheels are the components that provide a connection between the vehicle and the road. A wheel is conventionally made up of a rim and a tyre mounted thereon; the rim and the tyre define a substantially toroidal cavity there-between. The toroidal cavity may house an inner tube inflatable with a pressurised fluid, typically air; alternatively, in so-called tubeless tyres where no inner tube is provided for, the pressurised fluid directly fills the toroidal cavity. Valve means are provided for inflating the inner tube or, alternatively, for directly introducing the pressurised fluid into the toroidal cavity.

The wheels have the function of providing a pneumatic support to the vehicle and to the load thereof, as well as of ensuring a suitable road-holding performance.

The efficiency of the tyre greatly depends on the correct inflation pressure. An incorrect inflation pressure produces in particular an increase in the fuel consumption of the vehicle, a deterioration in the vehicle manoeuvrability, and a faster wear of the tyre. It is therefore of the outmost importance that the correct inflation of the tyre is carefully checked. Another extremely important parameter to be periodically checked is the tyre wear: a worn tyre compromises the vehicle road holding, and is therefore highly dangerous.

Vehicle and tyre manufacturers strongly recommend that the vehicle user check the tyre condition periodically, preferably before each ride. However, it has been realized that this kind of inspection, completely entrusted to the user, is not satisfactory. Additionally, the mere visual inspection of the tyres may not provide a reliable indication of the tyre wear.

Systems for monitoring characteristic parameters of the tyres during the vehicle ride have thus been proposed. One such system is disclosed in the European patent application No. EP-A-1057664, in the name of the Applicant of the present application. In that prior-art system, a radio-frequency transmission device receives from pressure sensors and/or temperature sensors associated with the tyres an indication of the tyre inflation pressure and/or temperature. The transmission device transmits to a notifying device a radio-frequency signal indicating the pressure and/or temperature values measured by the sensors. The notifying device includes LEDs or a display device for displaying to the vehicle user, during the vehicle ride, the pressure and/or temperature values measured by the sensors.

The system described in the cited document enables the vehicle user to be constantly informed on the conditions of the tyres, without the need of periodically checking the inflation pressure and/or the tyre wear.

The Applicant has observed that a drawback of that system is the necessity of having the notifying device mounted in a suitable place of the vehicle, normally on the vehicle dashboard, in such a way as to enable the associated LEDs or display device to be readable by the persons in the vehicle cabin. This drawback is particularly felt when the system is sold as an aftermarket kit to be installed on the vehicle.

The Applicant has provided a system that is capable of notifying the persons inside the vehicle of detected tyre operating conditions, without requiring the installation of dedicated signalling devices such as LEDs or display devices in a position visually accessible to the persons inside the vehicle.

The Applicant has realised that the vast majority of the vehicles are equipped with an on-board radio receiver system. Additionally, most of the radio receiver systems equipping the vehicles feature RDS (Radio Data System) functions (Radio Broadcast Data System—RBDS—in North America).

The Applicant has thus realised that the features of the RDS/RBDS radio receiver system already installed on a vehicle could be expediently exploited for signalling the detected tyre operating conditions to the persons inside the vehicle.

A first aspect of the present invention relates to a system for notifying detected tyre operating conditions of a vehicle comprising:

a receiving device for receiving tyre operating parameters detected by at least a sensor associated with at least a tyre of said vehicle, and

a notifying device for notifying to persons inside the vehicle an indication of said tyre operating conditions, determined on the basis of said received operating parameters,

characterised in that

said notifying device comprises a radio data system transmission module for generating a signal receivable by a RDS/RBDS radio receiver, and for transmitting the indication of the tyre operating conditions exploiting the RDS/RBDS protocol, thereby the persons inside the vehicle are notified of the tyre operating conditions through a RDS radio receiver installed on the vehicle.

Preferably, the notifying device comprises a microcontroller, fed by the receiving device, for determining a message to be notified on the basis of the received vehicle tyre operating parameters,

Preferably, the radio data transmission module comprises a message formatting device for formatting the message to be notified in accordance with the RDS/RBDS protocol, and a radio transmitter for generating a signal, carrying the formatted message, receivable by a standard vehicle RDS/RBDS radio receiver system.

Preferably, the system comprising a coupling device for coupling the radio transmitter to an RDS/RBDS radio receiver installed on the vehicle.

Preferably, the coupling device comprises an antenna coupler and an antenna cable connectable to an antenna input of the RDS/RBDS radio receiver installed on the vehicle.

Preferably, the receiving device is adapted to receive a radio signal transmitted by the sensors.

Preferably, the system further comprises an audio signal generator adapted to directly drive a loudspeaker system of the RDS radio receiver installed on the vehicle for acoustically notifying the indication of the tyre operating conditions.

Preferably, said sensors include pressure sensors associated with the tyres for measuring an inflation pressure thereof. Preferably, said sensors include temperature sensors associated with the tyres for measuring a temperature thereof.

A further aspect of the present invention relates to a method for notifying detected operating condition of the tyres of a vehicle comprising:
receiving tyre operating parameters from at least a tyre sensor (105) associated with at least a tyre of said vehicle, and
on the basis of the received tyre operating parameters, notifying an indication of the tyre operating conditions to persons inside the vehicle,
   characterised in that said notifying comprises:
transmitting said indication in a form compliant to the RDS/RBDS protocol, thereby the indication is receivable by a vehicle RDS/RBDS radio receiver.

The features and advantages of the present invention will be made apparent by the following detailed description of an embodiment thereof, provided merely by way of non-limiting example, which will be made with reference to the annexed drawings, wherein:

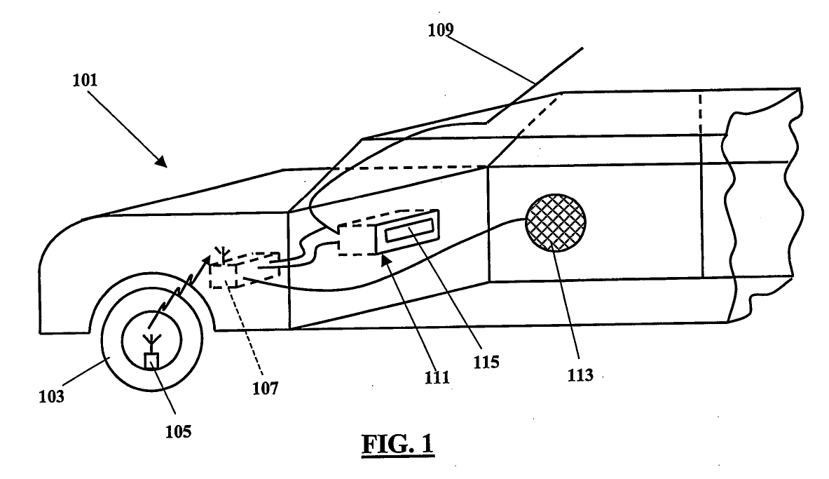

FIG. 1 is a pictorial view of a vehicle equipped with a system for notifying tyre operating conditions according to an embodiment of the present invention;

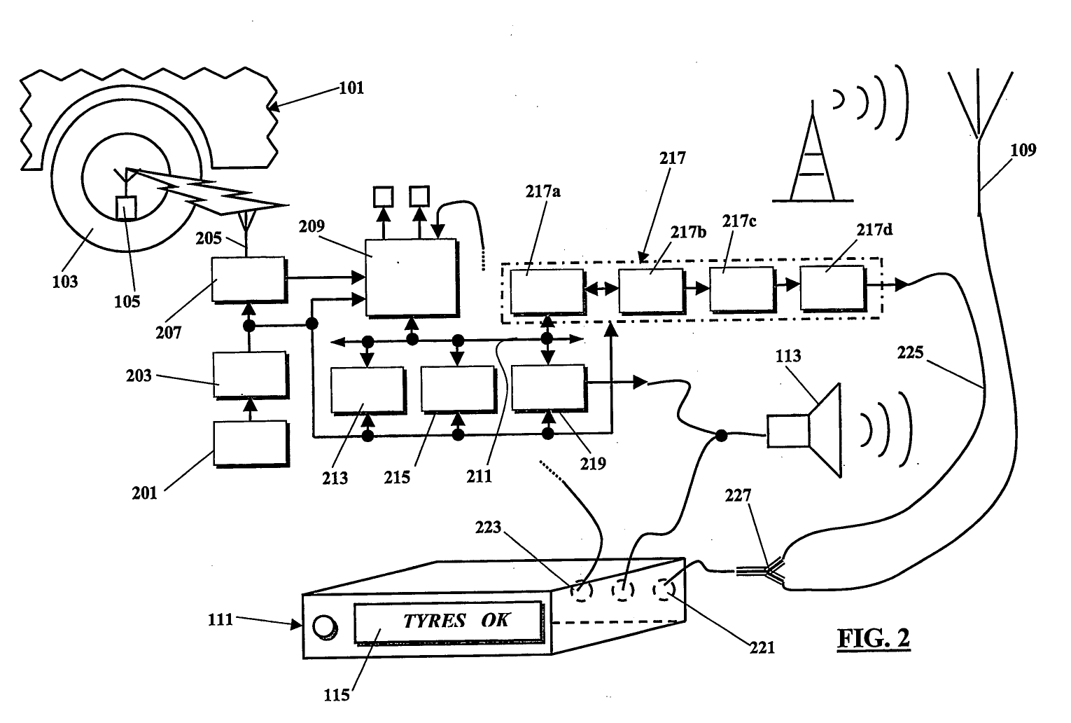

FIG. 2 is a schematic block diagram of the system of FIG. 1, in an embodiment of the present invention;

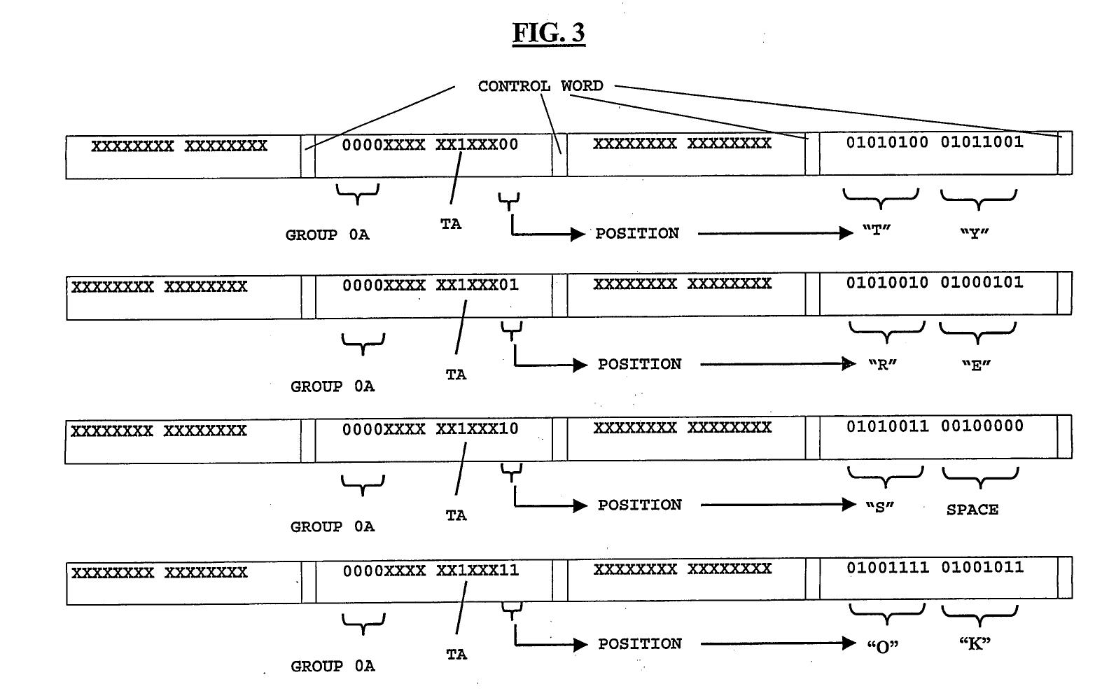

FIG. 3 schematically shows RDS data packets transmitted by the system for notifying tyre operating conditions, in an embodiment of the invention.

With reference to the drawings, FIG. 1 is a very high-level pictorial view of a vehicle, in the example a car 101, equipped with a system for notifying tyre operating conditions according to an embodiment of the present invention.

Each tyre 103 of the car 101 is equipped with a measuring device 105 measuring tyre operating parameters.

The measuring device 105 is for example of the type described in detail in the already cited European patent application No. EP-A-1057664, comprising a battery-supplied electronic circuit including a transmitter for transmitting, by means of electromagnetic waves, information relating to tyre operating parameters detected by one or more sensors associated with the tyre; the operating parameters include for example and non-limitatively the tyre inflation pressure and the tyre temperature. The transmitter preferably transmits at short-wave radio frequency, and particularly at a frequency chosen in the range from approximately 100 KHz to 1000 MHz. The transmission may be analogue or, preferably, digital.

Said system comprises a tyre operating condition monitoring device 107 installed within the car 101. The monitoring device 107 includes an electronic circuit, described in detail hereinafter, embedded in a casing in suitable material, for example metal or plastic. The monitoring device 107 can be installed in any suitable or available position within the car 101, for example inside the motor compartment, within the car cabin, inside the trunk or within one of the car doors. It is pointed out that, as will straightforwardly appear from the following, an advantage of the present invention is that it is absolutely not necessary that the monitoring device 107 be installed in correspondence of the car dashboard, or in general in a position visually accessible to the persons inside the car cabin.

Said monitoring device preferably comprises a receiving device for receiving tyre operating parameters detected by sensors associated with tyres of said vehicle, and a notifying device for notifying to persons inside the vehicle an indication of said tyre operating conditions, determined on the basis of said received operating parameters.

The monitoring device 107 is operatively coupled with a car radio receiver, comprising as usual an antenna 109 and one or more loudspeakers 113 driven by the radio receiver. The radio receiver 111 may include one or more additional functions, such as functions of CD or compact-cassette player, MP3 player, mobile phone, navigator. The antenna 109 is either aerial or embedded in the vehicle body, for example in the windshield.

The radio receiver 111 is preferably compatible with the Radio Data System (shortly, RDS) standard adopted by more and more radio broadcasters. In particular, the radio receiver 111 has a display device 115, typically a liquid crystal display. The display device 115 is exploited for displaying information transmitted by the radio broadcasters according to the RDS protocol. This information includes typically the station name, as well additional messages that the radio broadcasters whish to be displayed to the listeners.

In an embodiment of present invention, the monitoring device 107 is coupled to an antenna input of the radio receiver 111, by means of a conventional antenna cable: for example, a Y connector (227 in FIG. 2) is connected to the antenna input of the radio receiver 111, so that both the antenna cable coming from the antenna 109 and the antenna cable coming from the monitoring device 107 are connected to the antenna input of the radio receiver 111. In an alternative embodiment, the monitoring device 107 broadcasts radio signals, which are received by the radio receiver 111 through the antenna 109.

In a preferred embodiment of the invention, the monitoring device 107 is also coupled to the radio receiver 111 in such a way as to detect whether the radio receiver 111 is turned on or off, and is coupled (by conventional wires) to the loudspeaker(s) of the car radio receiver system to directly drive the loudspeaker(s), particularly in case the radio receiver 111 is detected as turned off. For example, the monitoring device 107 is connected to a mute output of the radio receiver 111.

Coming now to FIG. 2, a block diagram of an embodiment of the electronic circuit making up the monitoring device 107 is shown. In the shown embodiment, the monitoring device 107 is powered by an internal battery 201, preferably a lithium battery providing an output voltage of approximately 4.0 V and having a capacity of 150 mAh.

The battery 201 is connected to a voltage regulator 203 regulating the voltage supplied by the battery 201 and generating a stabilised output voltage of, for example, 3 V, supplying all the components of the electronic circuit. Preferably, the voltage regulator 203 is an integrated circuit with a low intake current and minimum input/output voltage difference; a suitable commercially available component is the MC78LC30 by Motorola.

Alternatively, the monitoring device 107 can be connected to the car battery. In this case, the internal battery 201 is not required, and the voltage regulator 203 must be capable of transforming the 12 V input voltage from the car battery into the stabilised 3 V output voltage.

The receiving device of said monitoring device 107 is for example of the type described in the already cited European patent application No. EP-A-1057664. The radio-frequency signal coming from the measuring device 105 is received by an antenna 205 connected to a receiver 207, for example the model RXNB-CE/433 by Auriel. The antenna 205 is for example formed by a short section of wire, the length of which depends on the frequency of the radio-frequency signal transmitted by the measuring device 105; by way of example, in the case of a frequency of 433.92 MHz the wire making up the antenna 205 is long about 5 cm.

The receiver device is connected to said notifying device which comprises a radio data system (RDS) transmission module.

In particular, said receiving device comprises a microcontroller 209, a signal bus 211, a working memory 213 and said RDS frequency-modulation (FM) transmission module 217.

Said microcontroller 209 is for example one of the PIC family produced and sold by Microchip; the signal received through the antenna 205 by the receiver 207 is suitably converted and fed to the microcontroller 209. The microcontroller 209 is connected, through said signal bus or a system of signal buses 211, to a plurality of peripheral devices, including the working memory 213, typically a Random Access Memory (RAM), a non-volatile memory 215, preferably of the electrically-programmable type such as a Flash or an EEPROM. Moreover said microcontroller is connected to the RDS frequency-modulation (FM) transmission module 217 and, in a preferred embodiment of the invention, is connected to an audio signal generator, particularly a voice synthesiser 219.

The RAM 213 is used by the microcontroller 209 as a temporary storage of data. The non-volatile memory 215 stores the microprogram to be executed by the microcontroller 209, as well as permanent data; the non-volatile memory 215 can also be used as a backup element for preserving relevant data in case of failure of the supply voltage. It is pointed out that the microcontroller 209 normally embeds a data RAM and a non-volatile program memory; if the size of these memory devices is considered sufficient, the external RAM 213 and non-volatile memory 215 could be not necessary.

The RDS FM transmission module 217 includes an RDS interface circuit 217a, an RDS microcontroller 217b, an FM modulator circuit 217c and an antenna coupler circuit 217d.

The RDS interface circuit 217a acts as a buffer between the microcontroller 209 and the RDS microcontroller 217b.

The RDS microcontroller 217b receives from the microcontroller 209, through the RDS interface circuit 217a, messages relating to the tyre operating conditions to be notified to the persons within the car cabin adopting the RDS protocol. The RDS microcontroller 217b generates RDS-compliant digital data packets, described in detail hereinafter, to be sent to the FM modulator circuit 217c.

The FM modulator circuit 217c generates a frequency-modulated signal over a preselected carrier wave in the FM radio broadcasting frequency range (from approximately 88 MHz to approximately 108 MHz). In particular, the FM modulator circuit 217c receives from the RDS microcontroller 217b the RDS-compliant digital data packets; as prescribed by the RDS standard, the data are transmitted by the FM modulator circuit 217c using a sub-carrier wave at 57 KHz, modulated according to the digital data using an NRZI coding. The frequency of the carrier wave can be predetermined or, preferably, programmable.

The antenna coupler circuit 217d couples the frequency-modulated signal generated by the FM modulator circuit 217c to the antenna 109 of the car radio receiver. In this embodiment of the invention, an output of the antenna coupler circuit 217c is hardwired, for example through a coaxial cable 225 and a Y connector 227, to the antenna input 219 of the radio receiver 111; alternatively, the output of the antenna coupler circuit 217c may be connected to the antenna cable connecting the antenna 109 to the antenna input 219 of the radio receiver 111. In still another embodiment of the invention, instead of a wire connection to the antenna cable, the RDS FM transmission module 217 broadcasts the signal through an antenna, and the signal is received by the car radio receiver system antenna 109.

In the preferred embodiment of the invention, the microcontroller 209 has an input connected to a mute output 223 of the car radio receiver 111, for detecting the turning on/off status thereof. The voice synthesiser 219, assumed to include a suitable amplifier, has an output hardwired to the loudspeaker(s) 113 for directly driving the loudspeaker(s).

In operation, the sensors provided in the measuring devices 105 mounted on the car wheels 103 detect the desired parameters of the respective tyre, for example the tyre pressure. The measuring devices 105 transmit information concerning the detected tyre parameters. For the transmission, an Amplitude-Shift Keying (ASK) modulation scheme is for example adopted.

Each measuring device 105 installed on the car wheels is assigned a univocal identification code that the measuring device 105 transmits together with the information on the detected tyre parameters. The identification codes of the measuring devices 105 installed on the car are also stored in the monitoring device 107, for example in the non-volatile memory 215. The identification codes of the measuring devices 105 may be assigned and programmed into both the measuring devices and the monitoring device during a configuration phase after the installation of the kit on the car. In the configuration phase, also the position of the wheel on which each measuring device is mounted is programmed into the monitoring device in association with the identification codes, thereby enabling the monitoring device to establish a one-to-one relationship between each measuring device and each wheel of the car; for example, the following information is programmed into the monitoring device in the configuration phase: [(MDIDa, FL); (MDIDb, FR); (MDIDc, RL); (MDIDd, RR)], where MDIDa, MDIDb, MDIDc and MDIDd represent the identification codes of the four measuring devices 105 mounted on the four wheels of the car, and FL, FR, RL and RR identify the front-left, the front-right, the rear-left and the rear-right wheels, respectively. Alternatively, the identification codes of the measuring devices may be assigned thereto and stored in the monitoring device 107 directly at the manufacturing stage.

Through the antenna 205, the receiver 207 of the monitoring device 107 receives and converts the data transmitted by the measuring devices 105. Schematically, the data received and converted by the receiver 207 can take the following form:
(MDIDa,P1),(MDIDb,P2),(MDIDc,P3),(MDIDd,P4)
   where P1, P2, P3 and P4 denote values of tyre inflation pressure detected by the sensors of the four measuring devices 105 mounted on the four car wheels. Clearly, the data from the different measuring devices 105 can be received in any order. Also, in addition to the tyre pressure, the detected values of other tyre operating parameters (e.g., the tyre temperature) can be transmitted by the measuring devices 105, altogether or individually.

The receiver 207 supplies the received data to the microcontroller 209.

The microcontroller 209 processes the data received from the measuring devices 105 for determining the tyre conditions and the kind of message to be notified to the car driver.

In particular, and by way of non-limitative example only, the microcontroller 209 determines the tyre conditions by comparing the inflation pressure values received from the measuring devices 105 to predefined inflation pressure values, stored for example in the non-volatile memory 215. Four inflation pressure values Pmin<Plow<Phigh<Pmax are for example defined and stored in the non-volatile memory 215; these values, which depends on the tyre type and vehicle type, are for example set during the configuration phase.

The microprocessor 209 determines the tyre condition according to the following logic:

| | |
|---|---|
| a) if Pi > Pmax | pressure too high - danger |
| b) if Phigh < Pi < Pmax | pressure high - need check |
| c) if Plow < Pi < Phigh | pressure OK |
| d) if Pmin < Pi < Plow | pressure low - need check |
| e) if Pi < Pmin | pressure too low - danger |

where Pi is the tyre pressure value received from any one of the measuring devices 105.

Preferably, the received data are stored in the working memory 213 or, even more preferably, in the non-volatile memory 215, so as to build a history table of the tyre behaviour.

Depending on the result of the comparison of the received tyre pressure values with the predefined values, the microcontroller 209 supplies to the RDS FM transmission module 217 a specific message to be notified to the persons in the car.

In particular, and by way of example only, if, on the basis of the most recently received values of tyre pressure of the four tyres:

all the tyres result to have a correct inflation pressure (Plow<Pi<Phigh), a normal condition message is to be notified to the car driver;

one or more of the tyres result to have an inflation pressure higher than the predefined pressure value Phigh, but lower than the maximum pressure value Pmax, a message indicating that the inflation pressure of such tyre or tyres is too high is to be notified to the car driver;

one or more of the tyres result to have an inflation pressure lower than the predefined pressure value Plow, but higher than the minimum pressure value Pmin, a message indicating that the inflation pressure of such tyre or tyres is too low is to be notified to the car driver;

one or more of the tyres result to have an inflation pressure higher than the maximum pressure value Pmax or lower than the minimum pressure value Pmin, a message indicating a dangerous condition in respect of such tyre or tyres is to be notified to the car driver.

A set of predefined message templates are for example defined and stored in the non-volatile memory 215. Each message template includes a predefined string of characters (for example coded according to the ASCII standard); some message templates allows including a variable body. The set of predefined message templates include for example the following message templates:
MSGT1: “TYRES OK”
MSGT2: (space for variable body) “HIGH”
MSGT3: (space for variable body) “LOW”
MSGT4: (space for variable body) “ALARM”.

The variable body of the message templates is filled in by the microcontroller 209 with character strings identifying the car wheels (for example, FL for the front-left wheel, FR for the front-right wheel, RL for the rear-left wheel and RR for the rear-right wheel) according to the result of the control performed on the most recently received inflation pressure values from each measuring device 105. For example, if the pressure value P1 received from the measuring device associated with the front-left wheel results to be Phigh<Pi<Pmax, the message template MSGT2 is selected, and the variable body is filled in with the string “FL”, the complete message thus being “FL HIGH”; if the pressure values P1 and P2 of both the front-left and the rear-left tyres falls within Phigh and Pmax, the variable body of the message template MSGT2 is filled in with the string “FL,RL”, so that the complete message is “FL,RL HIGH”, and so on.

It is to be observed that more than one message can be selected by the microprocessor 209 and supplied to the RDS FM transmission module 217, depending on the result of the calculation performed by the microcontroller 209. Different levels of priority can also be assigned to the different messages; for example, an ALARM message is assigned a higher priority than a HIGH or LOW message.

Once the microcontroller 209 has selected the message template or templates and, if necessary, completed it or them with the required variable body, the message or messages are fed to the RDS FM transmission module 217, possibly according to the respective priority level.

In particular, the RDS interface circuit 217a acts as a buffer for delivering, on a first-in-first-out basis, the messages received from the microcontroller 209 to the RDS microcontroller 217b.

The RDS microcontroller 217b puts the received strings of characters in a form complying with the RDS protocol. As known, the RDS protocol provides for transmitting the data in groups of 104 bits each. Each RDS data group is made up of four blocks of 26 bits each: 16 bits form the payload, while 10 bits form a control word; the control word is used for detecting transmission errors, as well as for identifying the block position within the RDS data group.

Different types of RDS data groups are defined, intended to carry different pieces of information. In principle, 32 different groups are defined.

Each RDS data group has a common body and a variable body. The common body includes data which, for a given radio broadcaster, have a same meaning irrespective of the type of RDS data group. The variable body includes data whose meaning varies depending on the type of RDS data group.

The common body of each RDS data group comprises the first block of bits and a portion of the second block of bits of the RDS data group. In particular, the first block of bits contains information for univocally identifying the radio station; such information include the so-called Program Identification (PI) code, defining the country of the radio station, the broadcasting type in terms of area of coverage (national, regional, etc.) and the radio station. In the second block of bits, the first four bits (starting from the most significant bit) contain a code identifying the type of RDS data group; a fifth bit is used as a flag for identifying the version of the transmitted RDS code (“A” or “B” version); a sixth bit is used as a flag (Traffic Program or, shortly, TP) for signalling that the radio station, during the day, broadcasts information concerning the traffic conditions; the following five bits (Program Type or, shortly, PTY) contain a code defining the type of program currently broadcasted by the radio station (news, affairs, sport, pop music, rock music etc.).

The information contained in the variable body of each RDS data group depends, as mentioned, on the type of the group.

In an RDS transmission, data groups of different type are normally broadcasted cyclically. One of the most frequently transmitted RDS data groups is the group 0 of version A (in the following, 0A group), containing basic information.

The variable body of the 0A group contains, in the remaining five bits of the second block of bits: a bit used as a Traffic Announcement (shortly, TA) flag that, when set, signals that the radio station is currently broadcasting information on the traffic conditions; a bit used as a Music/Speech (shortly, M/S) flag that signals whether the radio station is currently broadcasting a music or a speech program; a bit defined Decode Identify (shortly, DI) part of a four-bit code, transmitted one bit at a time with four successive 0A groups. The last two bits of the second block of bits of the OA group are used as a counter for defining the position, within a string of eight ASCII characters, of the two ASCII characters contained in the fourth block of bits of the 0A group; normally, the 0A group is used to transmit the name of the radio station, to be displayed onto the display of the car radio receiver. The third block of bits of the 0A group contains, coded in a prescribed manner, an indication of possible alternative frequencies for the same radio station.

According to an embodiment of the present invention, the RDS FM transmission module 217 transmits the messages received from the microcontroller 209, containing information relating to the tyre operating conditions to be notified to the car driver, exploiting the 0A group.

By way of example, if the message received from the microcontroller 209 is “TYRES OK”, the RDS microprocessors 217b compiles and provides to the FM modulator circuit the four OA groups shown in FIG. 3. The eight characters (in ASCII code) making up the message are transmitted two at a time. In the drawing, the Xs are used to indicate don't care logic states of those bits not relevant to the present description. Preferably, the TA flag is set (logic “1”).

The other possible messages received from the microcontroller 209 are compiled by the RDS microprocessor 217b in a similar way. In particular, when the message to be transmitted includes a string of more than eight characters, more than four OA groups need to be transmitted.

Alternatively, different types of RDS data groups can be exploited for transmitting the desired message. For example, the 2A data group allows transmitting four ASCII characters, and is therefore useful for transmitting relatively long messages.

The RDS data groups are then fed to the FM modulator circuit 217c that modulates the carrier wave at the preselected frequency; in particular, the bits making up the RDS data groups are transmitted on a sub-carrier at 57 KHz, using NRZI coding.

The frequency-modulated signal generated by the FM modulator circuit 217c is received by the radio receiver 111. Provided that the radio receiver 111 is tuned on the frequency of the carrier wave used by the FM modulator circuit 217c, the RDS data are received and decoded by the radio receiver 111 as the RDS data transmitted by conventional radio stations. In particular, the transmitted message is displayed on the display 115 of the radio receiver 111, thereby notifying the car driver of the tyre operating conditions, as pictorially shown in FIG. 1. Thanks to the fact that the TA flag is set, provided that the TA function is enabled in the radio receiver 111, when the RDS data groups transmitted by the RDS FM transmitter circuit 217 are received the message is displayed even if the CD or compact-cassette player function of the radio receiver 111 is currently in use.

If the radio receiver 111 so allows, the received message can also be notified acoustically, through the loudspeaker(s) 113.

In order not to permanently shadow the radio station transmitting over the same carrier wave frequency as the preselected carrier wave frequency on which the FM modulator circuit 217c transmits, the RDS FM transmission module 217 preferably transmits only on a periodical basis, for example every five minutes.

Preferably, the frequency of the carrier wave used by the FM modulator circuit 217c is chosen at the extremes of the FM frequency spectrum, where normally no radio stations are found. In this way, the problem of shadowing a radio station is limited. Even better, if the radio receiver has a frequency range slightly wider than the FM broadcast frequency range, the frequency of the carrier wave used by the FM modulator circuit 217c is chosen outside the FM broadcast frequency range.

In a preferred embodiment of the present invention, when the microcontroller 209 detects a dangerous condition in respect of one or more of the tyres (such as in the previously reported cases a) and e)), in addition to or instead of notifying the car driver by means of text messages, the microcontroller 209 instructs the audio signal generator 219 to generate an audio message, that can be a voice message or, simply, a tone or combination of tones. The audio message can be for example passed to the RDS FM transmission circuit 217, so as to be transmitted together with the RDS data groups, by the FM modulator circuit; alternatively, or in the case the microprocessor 209 detects that the radio receiver is off, the audio signal generator directly drives the loudspeaker(s) 113.

Although the present invention has been here disclosed by way of some embodiments, it is apparent to those skilled in the art that several modifications to the described embodiments, as well as other embodiments of the present invention are possible without departing from the scope thereof as defined in the appended claims. For example, the type of communication between the measuring devices 105 and the monitoring device 107 could be of a different type. The system could also notify the conditions of the spare tyre. Additionally, even though in the present detailed description reference has always been made to a radio receiver system compatible with the RDS standard, the invention clearly applies straightforwardly to radio receiver systems compatible with the RBDS standard, which is the North-American analogous of the RDS standard adopted for example in Europe.

1-9. (canceled)

10. A system for notifying detected tyre operating conditions, comprising:
a device for receiving tyre operating parameters detected by at least one sensor associated with at least one tyre of a vehicle; and
a device for notifying one or more persons inside the vehicle of an indication of operating conditions of the at least one tyre, determined on a basis of the received tyre operating parameters;
wherein the notifying device comprises a radio data system transmission module for generating a signal receivable by a radio receiver compatible with the Radio Data System (RDS) standard, the Radio Broadcast Data System (RBDS) standard, or the RDS and RBDS standards, and for transmitting the indication of the operating conditions of the at least one tyre, exploiting the RDS or RBDS protocol, and
wherein the one or more persons inside the vehicle are notified of the indication of the operating conditions of the at least one tyre through the radio receiver.

11. The system of claim 10, wherein the notifying device comprises a microcontroller for determining a message to be notified on the basis of the received tyre operating parameters,
wherein the microcontroller is fed by the receiving device, and
wherein the radio data system transmission module comprises:
a device for formatting the message to be notified in accordance with the RDS or RBDS protocol, and
a radio transmitter for generating the signal, carrying the formatted message, receivable by the radio receiver.

12. The system of claim 11, further comprising a device for coupling the radio transmitter to the radio receiver.

13. The system of claim 12, wherein the coupling device comprises:
an antenna coupler; and
an antenna cable connectable to an antenna input of the radio receiver.

14. The system of claim 10, wherein the receiving device is adapted to receive a radio signal transmitted by the at least one sensor.

15. The system of claim 10, further comprising an audio signal generator adapted to directly drive a loudspeaker system of the radio receiver for acoustically notifying the indication of the operating conditions of the at least one tyre.

16. The system of claim 10, wherein the at least one sensor includes one or more pressure sensors associated with the at least one tyre for measuring inflation pressure of the at least one tyre.

17. The system of claim 10, wherein the at least one sensor includes one or more temperature sensors associated with the at least one tyre for measuring temperature of the at least one tyre.

18. A method for notifying detected tyre operating conditions, comprising:
receiving tyre operating parameters from at least one sensor associated with at least one tyre of a vehicle; and
on a basis of the received tyre operating parameters, notifying an indication of the operating conditions of the at least one tyre to one or more persons inside the vehicle;
wherein the notifying comprises transmitting the indication of the operating conditions of the at least one tyre in a form compliant with the Radio Data System (RDS) or Radio Broadcast Data System (RBDS) protocol, and
wherein the indication of the operating conditions of the at least one tyre is receivable by a radio receiver compatible with the RDS standard, the RBDS standard, or the RDS and RBDS standards.
